(19) United States
(12) Patent Application Publication
(10) Pub. No.: US 2015/0025118 A1
(43) Pub. Date: Jan. 22, 2015

(54) ACTIVE COMPOUND COMPOSITIONS FOR VECTOR CONTROL OF INSECTICIDE-RESISTANT PESTS

(71) Applicant: BAYER INTELLECTUAL PROPERTY GMBH, Monheim (DE)

(72) Inventors: Rainer Sonneck, Leverkusen (DE); Sebastian Horstmann, Leverkusen (DE)

(21) Appl. No.: 14/375,523

(22) PCT Filed: Feb. 4, 2013
(86) PCT No.: PCT/EP2013/052177

§ 371 Date: Jul. 30, 2014

(30) Foreign Application Priority Data
Feb. 8, 2012 (EP) 12154470.4

(51) Int. Cl. A01N 43/30; A01N 43/08; A01N 43/78

(52) U.S. Cl. CPC A01N 43/30; A01N 43/78; A01N 43/08
USPC 514/365; 514/465

(57) ABSTRACT

The invention is in the technical field of vector control and in particular mosquito and bed bug control. The active compound compositions of this invention are used against animal pests such as arthropods which transmit disease pathogens or which annoy the well-being of humans and animals. The active compound compositions of this invention are in particular useful to overcome target-specific and/or metabolic-specific resistance of mosquitos and bed bugs.

The invention is in the technical field of vector control and in particular mosquito and bed bug control. The active compound compositions of this invention are used against animal pests such as arthropods which transmit disease pathogens or which annoy the well-being of humans and animals. The active compound compositions of this invention are in particular useful to overcome target-specific and/or metabolic-specific resistance of mosquitos and bed bugs.

The present invention relates to new active compound compositions which have very good insecticidal and arachnidial properties and which comprise firstly the known active carbamate compounds bendiocarb or propoxur and secondly at least one further known insecticidal active compound selected from the group of neonicotinoids and phenylpyrazoles.

It is known that bendiocarb or propoxur can be employed for controlling animal pests, in particular insects. While the activity of these compounds is good, they need to be applied at high dose rates in some cases in particular in connection with resistance management of mosquitos and/or bed bugs. It has been also disclosed that neonicotinoids such as acetamiprid, clothianidin, dinotefuran, imidacloprid, nitenpyram, thiacloprid and thiamethoxam can be used for controlling unwanted pests. Moreover, it is known that phenylpyrazoles such as ethiprole and fipronil are useful to control unwanted pests. Bendiocarb, propoxur, neonicotinoids and phenylpyrazoles are known and described e.g. in “The Pesticide Manual”, 15th Edition, British Crop Protection Council (bendiocarb, page 79; propoxur, page 956; acetamiprid, page 9; clothianidin, page 229; dinotefuran, page 391; imidacloprid, page 645; nitenpyram, page 817; thiacloprid, page 1111; thiamethoxam, page 1112; ethiprole, page 443; fipronil, page 500).

Due to natural selection pests develop a resistance to chemicals and therefore there is a continuous need to improve the current available active compounds or active compound combinations in order to allow an efficient resistance management.

With the present invention it has now been found that active compound compositions comprising bendiocarb or propoxur (herein referred to as active compounds of group A) and secondly at least one further active compound selected from the group of neonicotinoids and phenylpyrazoles (herein referred to as active compounds of group B) are synergistically active and are suitable for controlling animal pests and in particular to control insecticide-resistant animal pests. Owing to this synergism, markedly lower amounts of active compound may be used and/or an existing insecticide resistance can be overcome, that is to say the effect of the mixture exceeds the effect of the individual components. The synergism is in particular surprising in connection with the control of insecticide-resistant mosquitos and/or bed bugs.

The term neonicotinoids according to this invention refers preferably to a compound selected from the group of acetamiprid, clothianidin, dinotefuran, imidacloprid, nitenpyram, thiacloprid and thiamethoxam.

The term phenylpyrazoles according to this invention refers preferably to a compound selected from the group of ethiprole and fipronil.

In a preferred embodiment the active compound composition of the invention comprises preferably as an active compound from group A bendiocarb.

In another preferred embodiment the active compound composition of the invention comprises preferably as an active compound from group B a compound selected from the group of clothianidin and dinotefuran.

The active compound compositions of this invention are used to control animal pests, preferably arthropods and more preferably sucking, stinging and chewing insects and arachnids.

The arachnids include essentially mites (for example Sarcoptes scabiei, Dermatophagoides pteronyssinus, Dermatophagoides farinae, Dermanyssus gallinae, Acarus siro) and ticks (for example Ixodes ricinus, Ixodes scapularis, Argas reflexus, Ornithodorus moubata, Rhipicephalus (Boophilus) microplus, Amblyomma hebraeum, Rhipicephalus sanguineus).

The sucking and stinging insects include essentially the mosquitoes (for example Aedes aegypti, Aedes albopictus, Aedes vexans, Culex quinquefasciatus, Culex tarsalis, Anopheles albimanus, Anopheles stephensi, Anopheles gambiae, Anopheles funestus, Mansonia titillans); the sandflies (for example Phlebotomus papatasii), gnats (for example Culicoides furens), black flies (for example Simulium damnosum); flies such as stinging flies (for example Stomoxys calcitrans), tsetse flies (for example Glossina morsitans morsitans), horse flies (for example Tabanus nigrovittatus, Haematopota pluvialis, Chrysops caecutiens), true flies (for example Musca domestica, Musca autumnalis, Musca vetustissima, Fannia canicularis), flesh flies (for example Sarcophaga carnaria), myiasis-causing flies (for example Lucilia cuprina, Chrysomyia chloropyga, Hypoderma bovis, Hypoderma lineatum, Dermatobia hominis, Oestrus ovis, Gasterophilus intestinalis, Cochliomyia hominivorax); bugs (for example Cimex lectularius, Rhodnius prolixus, Triatoma infestans); lice (for example Pediculus humanis, Haematopinus suis, Damalina ovis); fleas (for example Pulex irritans, Xenopsylla cheopis, Ctenocephalides canis, Ctenocephalides felis), sand fleas (Tunga penetrans), wasps (for example Vespula germanica).

The chewing insects include essentially cockroaches (for example Blattella germanica, Periplaneta americana, Blatta orientalis, Supella longipalpa); beetles (for example Sitiophilus granarius, Tenebrio molitor, Dermestes lardarius, Stegobium paniceum, Anobium punctatum, Hylotrupes bajulus), termites (for example Reticulitermes lucifugus); ants (for example Lasius niger, Monomorium pharaonis); and larvae of moths (for example Ephestia elutella, Ephestia cautella, Plodia interpunctella, Hofmannophila pseudospretella, Tineola bisselliella, Tinea pellionella, Trichophaga tapetzella).

Even more preferred, the active compound compositions of the present invention are used to control insects and arachnids selected from the group of mosquitos, ticks, flies, bed bug (Cimex lectularius), ants, beetles, cockroaches and/or termites. Even more preferred, the active compound compositions of the present invention are used to control mosquitos and/or bed bugs.

A further embodiment of the invention relates to the use of the active compound compositions according to the invention to control insecticide-resistant mosquitos and/or insecticide-resistant bed bugs and more preferably mosquitos and/or bed bugs that are target-site- and/or metabolic-resistant. Target-site resistance refers to a form of biochemical resistance which occurs when the insecticide compound no longer binds to its target, and metabolic-resistance refers to a form of biochemical resistance which occurs when levels or modified activities of esterases, oxidases, or glutathione S-transferases (GST) prevent an insecticide compound from reaching its site of action.

In another preferred embodiment the active compound compositions of the present invention are preferably used to control insecticide-resistant mosquitos wherein the insecticide-resistant mosquitos are selected from the group of Anopheles gambiae, preferably the strain RSPH and Anopheles funestus, preferably the strain FUMOZ-R. In another preferred embodiment the active compound compositions of the present invention are used to control pyrethroid and/or carbamate-resistant mosquitos, preferably pyrethroid and/or carbamate-resistant Anopheles gambiae and/or Anopheles funestus mosquitos. More preferably, the active compound compositions of the present invention are used to control pyrethroid-resistant mosquitos, preferably pyrethroid-resistant Anopheles gambiae and/or Anopheles funestus mosquitos. Another preferred embodiment of the invention relates to the active compound compositions of the present invention used to control multi-resistant mosquitos.

The invention also relates to the use of an active compound composition according to the invention to control pyrethroid-resistant bed bugs. In a preferred embodiment, the active compound composition of the invention is used to control pyrethroid-resistant bed bugs, wherein the bed bugs have a Valine to Leucine mutation (V419L) and/or a Leucine to Isoleucine mutation (L925I) in the voltage-gated sodium channel alpha-subunit gene.

Another embodiment of the invention relates to a method to control animal pests, preferably arthropods, preferably insects and more preferably mosquitos and/or bed bugs in particular insecticide-resistant mosquitos and/or insecticide-resistant bed bugs and more preferably mosquitos and/or bed bugs that are target-site- and/or metabolic-resistant. Another preferred embodiment relates to a method to control insecticide-resistant mosquitos wherein the insecticide-resistant mosquitos are selected from the group of Anopheles gambiae, preferably the strain RSPH and Anopheles funestus, preferably the strain FUMOZ-R. In another preferred embodiment the current invention relates to a method to control pyrethroid and/or carbamate-resistant mosquitos, preferably pyrethroid and/or carbamate-resistant Anopheles gambiae and/or Anopheles funestus mosquitos with the active compound composition of the invention. More preferably, the current invention relates to a method to control pyrethroid-resistant mosquitos, preferably pyrethroid-resistant Anopheles gambiae and/or Anopheles funestus mosquitos with the active compound composition of the invention. Another preferred embodiment of the invention relates to a method to control multi-resistant mosquitos with the active compound composition of the invention.

The invention also relates to a method to control of pyrethroid-resistant bed bugs with the active compound composition of the invention. More preferably, the current invention relates to a method to control pyrethroid-resistant bed bugs that have a Valine to Leucine mutation (V419L) and/or a Leucine to Isoleucine mutation (L925I) in the voltage-gated sodium channel alpha-subunit gene.

Another embodiment of the invention relates to a method to overcome insecticide resistance, preferably a target-site and/or metabolic-resistance, in mosquitos and/or bed bugs by applying an active compound composition according to invention to mosquitos and/or bed bugs that have insecticide-resistance respectively a target-site and/or metabolic-resistance. In a preferred embodiment, the invention relates to a method to overcome insecticide resistance in insecticide-resistant mosquitos selected from the group of Anopheles gambiae, preferably the strain RSPH and Anopheles funestus, preferably the strain FUMOZ-R by applying an active compound composition of the invention to such mosquitos. In another preferred embodiment the current invention relates to a method to overcome pyrethroid and/or carbamate resistance in mosquitos, preferably in Anopheles gambiae and/or Anopheles funestus mosquitos, by applying an active compound composition of the invention to such mosquitos. More preferably, the active compound compositions of the present invention are used to overcome insecticide resistance in pyrethroid-resistant mosquitos, preferably pyrethroid-resistant Anopheles gambiae and/or Anopheles funestus mosquitos. Another preferred embodiment of the invention relates to a method to overcome multi-resistance in mosquitos by applying an active compound composition of the invention to such multi-resistant mosquitos.

The invention also relates to a method to overcome pyrethroid resistance by applying an active compound composition according to invention to bed bugs that have pyrethroid resistance. More preferably, the active compound compositions of the present invention are used to overcome insecticide resistance in pyrethroid-resistant bed bugs that have a Valine to Leucine mutation (V419L) and/or a Leucine to Isoleucine mutation (L925I) in the voltage-gated sodium channel alpha-subunit gene.

The phrase “to overcome insecticide-resistance” refers to the observation that the active compound combination of the invention is more efficient in killing a certain insecticide-resistant mosquito than a similarly concentrated active compound from an insecticidal class towards which such an insecticide-resistant mosquito has developed a resistance.

Anopheles gambiae, the strain RSPH is a multi-resistant mosquito (target-site and metabolic-resistance) that is described in the reagent catalog of the Malaria Research and Reference Reagent Resource Center (www.MR4.org; MR4-number: MRA-334).

Anopheles funestus, strain FUMOZ-R is a metabolic-resistant strain and is described in Hunt et al., Med Vet Entomol. 2005 September; 19(3):271-5). In this article it has been reported that Anopheles funestus—as one of the major malaria vector mosquitos in Africa—showed resistance to pyrethroids and carbamate insecticides in South Africa.

Certain Bed bugs are known to be resistant to pyrethroids, wherein the pyrethroids resistance can be ascribed to metabolic resistance such as increased metabolic detoxification by P450s, glutathione transferases, and esterases as well as target-site resistance due to decreased target-site sensitivity of voltage-gated sodium channels. It has been also reported that a Valine to Leucine mutation (V419L) and/or the Leucine to Isoleucine mutation (L925I) in voltage-gated sodium channel alpha-subunit gene is responsible for target-site resistance to deltamethrin in bed bugs (Fan Zhu et al., Archives of Insect Biochemistry and Physiology, 2010, Vol. 00, No 0, 1-13).

Pyrethroid and/or carbamate-resistant mosquitos are mosquitos that are resistant to the treatment of pyrethroid insecticides and/or carbamate insecticides. Pyrethroid insecticides are e.g. allethrin, bifenthrin, cyfluthrin, cypermethrin, cyphenothrin, deltamethrin, esfenvalerate, etofenprox, fenpropathrin, fenvalerate, flucythrinate, imiprothrin, lambda-cyhalothrin, metofluthrin, permethrin, prallethrin resmethrin, silafluofen, sumithrin, tau-fluvalinate, tefluthrin, tetramethrin, tralomethrin, transfluthrin. Carbamate insecticides are e.g. aldicarb, benfuracarb, carbaryl, carbofuran, carbosulfan, fenobucarb, methiocarb, methomyl, oxamyl, thiodicarb, triazamate.

Insecticide-resistant mosquitos refers to mosquitos that are resistant to at least one insecticide chemical class.

Multi-resistant mosquitos refers to a mosquitos where several different resistance mechanisms are present simultaneously such as target-site resistance and metabolic resistance. The different resistance mechanisms may combine to provide resistance to multiple classes of products (IRAC publication: “Preventation and Management of Insecticide Resistance in Vectors of Public Health Importance”; second edition; 2011).

The active compound compositions according to the invention may comprise further components, for example additional active compounds of a different type (e.g. other insecticides, antibacterial compounds, fungicides, herbicides etc.) and/or additives customary in crop protection and/or formulation auxiliaries, or may be used together with these compounds.

In a preferred embodiment, the active compound combinations according to the invention have synergistic actions preferably in regard to the above outlined uses. The synergistic actions can be observed, for example, when commercially available formulations of active compounds of group A and group B or pure technical compounds of group A and group B are applied together.

The synergistic effects permit a reduction of the application rates, a higher efficacy at the same application rate and/or a reduction in the number of individual applications required and/or to overcome an existing insecticide resistance and—as a result for the user—an economically and ecologically improved control of animal pests and in particular an improved resistant management of mosquitos.

For example, the combinations of the active compounds of group A and group B allow the activity to be synergistically enhanced in a manner which far and unexpectedly exceeds the activities which can be achieved with the formulations of the individual active compounds of group A and group B.

The ratio of the compounds of group A employed to the compounds of group B, and the total amount of the mixture to be employed, depend on the species and the occurrence of the arthropods. The optimal ratios and overall rates used can be determined for each application by test series.

The application rate of the active compound combinations according to the invention varies preferably within ranges of between 0.001 and 1000 mg/m², more preferably, 2 and 500 mg/m² and even more preferred between 5 and 250 mg/m².

The mixing ratio of the active compounds of bendiocarb (compound of group A) with dinotefuran (compound of group B) is advantageously and preferably for the use of mosquitos from 1:1 to 1:200, preferably from, 1:1 to 1:125, more preferably from 1:5 to 1:125, even more preferably from 1:25 to 1:125.

The mixing ratio of the active compounds of bendiocarb (compound of group A) with clothianidin (compound of group B) is advantageously and preferably for the use of mosquitos from 1:100 to 1:800, preferably from 1:125 to 1:700 and even more preferably from 1:150 to 1:625.

As a further unexpected result it has been found that the combination of bendiocarb and clothianidin is efficient against the herein discussed pests (and in particular mosquitoes) on surfaces such as concrete and wood even though it is known that clothianidin alone is not efficient on wood and the alkaline-sensitive bendiocarb alone is not efficient on concrete (the latter of which is alkaline).

The active compound combinations of the invention can be converted to the customary formulations, such as solutions, emulsions, wettable powders, suspensions, powders, dusts, pastes, soluble powders, granules, suspension-emulsion concentrates, tablets, bait formulations, smoke producing formulations, gels, foams, aerosols, natural materials impregnated with the active compound combinations of the invention, synthetic materials impregnated with the active compound combinations of the invention and microencapsulations of the active compound combinations of the invention in polymeric substances. These formulations can be used directly, as “ready to use”, or after dilution in the application medium.

These formulations are produced in a known manner, for example by mixing the active compounds/active compound combination with extenders, that is liquid solvents and/or solid carriers, optionally with the use of surfactants, that is emulsifiers and/or dispersants, adjuvants, that is substances which improve the biological performance without having an own biological activity, antifoam, preservatives, antioxidants, colourants, anti freeze, pH stabilizers, thickeners, and/or foam-formers.

Suitable for use as auxiliaries are substances which are suitable for imparting to the active compounds/active compound combination itself and/or to preparations derived therefrom (for example spray liquors, seed dressings) particular properties such as certain technical properties and/or also particular biological properties. Typical suitable auxiliaries are: extenders, solvents and carriers.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethylformamide and dimethyl sulphoxide, and also water.

Suitable solid carriers are: for example, ammonium salts and ground natural minerals such as kaolins, clays, talc, chalk, quartz, attapulgite, montmorillonite or diatomaceous earth, and ground synthetic minerals, such as finely divided silica, alumina and silicates; suitable solid carriers for granules are: for example, crushed and fractionated natural rocks such as calcite, marble, pumice, sepiolite and dolomite, and also synthetic granules of inorganic and organic meals, and granules of organic material such as paper, sawdust, coconut shells, maize cobs and tobacco stalks; suitable emulsifiers and/or foam-formers are: for example, nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolyzates; suitable dispersants are nonionic and/or ionic substances, for example from the classes of the alcohol-POE- and/or -POP-ethers, acid and/or POP-POE esters, alkyl aryl and/or POP-POE ethers, fat- and/or POP-POE adducts, POE- and/or POP-polyol derivatives, POE- and/or POP-sorbitan- or -sugar adducts, alkyl or aryl sulphates, alkyl- or arylsulphonates and alkyl or aryl phosphates or the corresponding PO-ether adducts. Furthermore, suitable oligo- or polymers, for example those derived from vinylic monomers, from acrylic acid, from EO and/or PO alone or in combination with, for example, (poly)alcohols or (poly)amines. It is also possible to employ lignin and its sulphonic acid derivatives, unmodified and modified celluloses, aromatic and/or aliphatic sulphonic acids and their adducts with formaldehyde.

Thickeners such as carboxymethylcellulose and natural and synthetic polymers in the form of powders, granules or latices, such as gum arabic, polyvinyl alcohol and polyvinyl acetate, as well as natural phospholipids such as cephalins and lecithins, and synthetic phospholipids, can be used in the formulations. Further additives may be mineral and vegetable oils.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

The active compound composition of the invention can be used for liquid applications such as e.g a spray solution to control animal pests on a variety of surfaces. The treatment of surfaces for example within or outside from buildings is necessary to control spreading of diseases that are transmitted by arthropods such as insects or arachnids (such as for example mosquitos or bed bugs) that transmit diseases or that annoys animals and humans. There is a great need for protecting the inhabitants effectively and with a long-lasting residuality. Moreover, reasons of hygiene and structural engineering require that animal pests be prevented from entering into buildings, spreading and dwelling in buildings and infesting wood or other materials.

Other uses include the intergration or coating of the active compound composition according to the invention into/of materials such as pellets, granules, dusts, yarns, foils, sleeping mats, mosquito nets, textiles, wovens, braids, knits, felts, nonwovens, curtains, draperies, tarpaulins, fabrics, wood, papers, furnitures, fences in particular animal fences, paints etc. (integration of active ingredients into foils and mosquito nets is e.g. described in WO-A-2009/121580; PCT/EP2011/0055822, WO2011/128380).

The present invention also relates to a material which comprises the active compound composition of the invention. The material is preferably selected from the group of foil, sleeping net, sleeping mat, mosquito net, textile, woven, braid, knit, felt, nonwoven, curtain, drapery, tarpaulin, fabric, wood, paper, furniture, fence preferably animal fence, paint.

Another preferred embodiment of the invention relates to a bed bug bait which comprises the active compound composition of the invention and means to attract bed bugs. Means to attract bed bugs are know to a skilled person in the art (see e.g WO 2011/149899).

Alternatively, in another embodiment of the invention, the active compound combination is used to control bed bugs via an ovicidial activity. For this purpose, the active compound combination of the invention is applied to (e.g. sprayed on) bed bugs and eggs directly (such as e.g. on bedsprings, box springs, and the interior of bed frames or headboards, including all cracks and joints).

A further embodiment of this invention relates to the use of the above described material to control animal pests, preferably arthropods, preferably insects and more preferably mosquitos and/or bed bugs in particular insecticide-resistant mosquitos and/or insecticide-resistant bed bugs and more preferably mosquitos and/or bed bugs that are target-site- and/or metabolic-resistant. Another preferred embodiment relates to the use of such a material to control insecticide-resistant mosquitos wherein the insecticide-resistant mosquitos are selected from the group of Anopheles gambiae, preferably the strain RSPH and Anopheles funestus, preferably the strain FUMOZ-R. In another preferred embodiment the current invention relates to the use of such a material to control pyrethroid and/or carbamate-resistant mosquitos, preferably pyrethroid and/or carbamate-resistant Anopheles gambiae and/or Anopheles funestus mosquitos. More preferably, the material of the present invention is used to control pyrethroid-resistant mosquitos, preferably pyrethroid-resistant Anopheles gambiae and/or Anopheles funestus mosquitos. Another preferred embodiment of the invention relates to the use of such a material to control multi-resistant mosquitos.

The invention also relates to the use of the above described material to control pyrethroid-resistant bed bugs. In a preferred embodiment, the material is used to control pyrethroid-resistant bed bugs, wherein the bed bugs have a Valine to Leucine mutation (V419L) and/or a Leucine to Isoleucine mutation (L925I) in the voltage-gated sodium channel alpha-subunit gene.

The good insecticidal activity of the active compound combinations is illustrated by the examples below. Whereas the individual active compounds show weaknesses in their activity, the combinations show an activity which exceeds a simple addition of activities.

A synergistic effect of the active compound combination is always present when the activity of the active compound combination exceeds the total of the activities of the active compounds when applied individually.

The expected activity for a given combination of two active compounds can be calculated according to S. R. Colby, Weeds 15 (1967), 20-22 as follows:

### If

X is the kill rate, expressed in % of the untreated control, when active compound A is applied at an application rate of m g/ha or at a concentration of m ppm,
Y is the kill rate, expressed in % of the untreated control, when active compound B is applied at an application rate of n g/ha or at a concentration of n ppm and
E is the kill rate, expressed in % of the untreated control, when active compounds A and B are applied at application rates of m and n g/ha or at a concentration of m and n ppm,
   then

$$E = X + Y - \frac{X \cdot Y}{100}$$

If the actual insecticidal kill rate is greater than calculated, the kill of the combination is superadditive, i.e. there is a synergistic effect. In this case, the actual observed kill rate has to be greater than the value for the expected kill rate (E or hereinafter in the tables also Colby exp. %) calculated from the formula given above.

If, in the context of this description, the short form of the “common name” of an active compound is used, this comprises in each case all customary derivatives, such as the esters and salts, and isomers, in particular optical isomers, especially the commercially available form or forms. If the “common name” refers to an ester or a salt, this in each case also comprises all other customary derivatives, such as other esters and salts, the free acids and neutral compounds, and isomers, in particular optical isomers, especially the commercially available form or forms.

### EXAMPLES

### Aedes Test

### Solvent: Acetone

To produce a suitable preparation of active compound combination the active compounds bendiocarb and clothianidin were dissolved in acetone (for the control group only one active compound was dissolved in acetone). The active compound combination preparation (and the active compound preparations) were pipetted onto a glazed tile and, after drying, adult mosquitoes of the species Aedes aegypti are placed onto the treated tile. The exposition time is 30 minutes.

0.25 hours, 0.5 hours, 1 hour, 2 hour, 3 hour, 4 hour and 24 hours after contact to the treated surface, the knock-down proportion of the test animals in % is determined. Here, 100% means that all mosquitoes have been killed; 0% means that none of the mosquitoes has been killed.

TABLE 1
Clothianidin and Bendiocarb/Aedes aegypti

| | Concentration/ | Concentration/ | | Hours after contact to | | | | | | |
|---|---|---|---|---|---|---|---|---|---|---|
| | mg/m² | mg/m² | | the treated surface | | | | | | |
| | Clothianidin | Bendiocarb | | 0.25 h | 0.5 h | l h | 2 h | 3 h | 4 h | 24 h |
| Control | 0 | 0 | Effect % | 0 | 0 | 0 | 0 | 10 | 10 | 30 |
| Clothianidin | 20 | 0 | Effect % | 0 | 15 | 20 | 15 | 10 | 10 | 30 |
| alone | 5 | 0 | Effect % | 5 | 5 | 5 | 5 | 5 | 10 | 15 |
| Bendiocarb | 0 | 0.16 | Effect % | 0 | 5 | 5 | 5 | 10 | 10 | 5 |
| alone | 0 | 0.032 | Effect % | 0 | 0 | 0 | 0 | 0 | 5 | 0 |
| | 20 | 0.16 | Effect % | 5 | 95 | 100 | 100 | 100 | 100 | 100 |
| | 20 | 0.16 | Colby | 0 | 19 | 24 | 19 | 19 | 19 | 34 |
| | | | exp. % | | | | | | | |
| | 20 | 0.032 | Effect % | 10 | 15 | 15 | 15 | 5 | 10 | 10 |
| | 20 | 0.032 | Colby | 0 | 15 | 20 | 15 | 10 | 15 | 30 |
| | | | exp. % | | | | | | | |
| | 5 | 0.16 | Effect % | 0 | 0 | 45 | 40 | 55 | 50 | 30 |
| | 5 | 0.16 | Colby | 5 | 10 | 10 | 10 | 15 | 19 | 19 |
| | | | exp. % | | | | | | | |
| | 5 | 0.032 | Effect % | 5 | 10 | 10 | 10 | 15 | 15 | 20 |
| | 5 | 0.032 | Colby | 5 | 5 | 5 | 5 | 5 | 15 | 15 |
| | | | exp. % | | | | | | | |

### Target-Site-Resistant and Metabolic-Resistant Anopheles Test

### Solvent: Acetone

To produce a suitable preparation of active compound combination the active compounds bendiocarb and dinotefuran (table 2) or clothianidin (table 3) were dissolved in acetone (for the control group only one active compound was dissolved in acetone). The active compound combination preparation (and the active compound preperations) were pipetted onto a glazed tile and, after drying, adult mosquitoes of the species Anopheles gambiae (target-site-resistant and metabolic-resistant strain: RSPH) are placed onto the treated tile. The exposition time is 30 minutes.

0.25 hours, 0.5 hours, 1 hour, 2 hour, 3 hour, 4 hour and 24 hours after contact to the treated surface, the knock-down proportion of the test animals in % is determined. Here, 100% means that all mosquitoes have been killed; 0% means that none of the mosquitoes has been killed.

TABLE 2
Dinotefuran and Bendiocarb/Anopheles gambiae

| | Concentration/ | Concentration/ | | Hours after contact to | | | | | | |
|---|---|---|---|---|---|---|---|---|---|---|
| | mg/m² | mg/m² | | the treated surface | | | | | | |
| | Dinotefuran | Bendiocarb | | 0.25 h | 0.5 h | l h | 2 h | 3 h | 4 h | 24 h |
| Control | 0 | 0 | Effect % | 0 | 0 | 0 | 0 | 0 | 0 | 15 |
| Dinotefuran | 4 | 0 | Effect % | 15 | 5 | 15 | 40 | 35 | 65 | 65 |
| alone | 0.8 | 0 | Effect % | 10 | 5 | 5 | 10 | 20 | 30 | 35 |
| Bendiocarb | 0 | 0.8 | Effect % | 95 | 100 | 100 | 100 | 100 | 100 | 100 |
| alone | 0 | 0.16 | Effect % | 5 | 90 | 95 | 100 | 100 | 90 | 90 |
| | 0 | 0.032 | Effect % | 5 | 5 | 15 | 10 | 10 | 15 | 35 |
| Dinotefuran | 4 | 0.8 | Effect % | 100 | 100 | 100 | 100 | 100 | 100 | 100 |
| and | 4 | 0.8 | Colby | 96 | 100 | 100 | 100 | 100 | 100 | 100 |
| Bendiocarb | | | exp. % | | | | | | | |
| | 4 | 0.16 | Effect % | 0 | 100 | 100 | 100 | 100 | 100 | 100 |
| | 4 | 0.16 | Colby | 19 | 91 | 96 | 100 | 100 | 97 | 97 |
| | | | exp. % | | | | | | | |
| | 4 | 0.032 | Effect % | 5 | 5 | 35 | 80 | 90 | 100 | 100 |
| | 4 | 0.032 | Colby | 19 | 10 | 28 | 46 | 42 | 70 | 77 |
| | | | exp. % | | | | | | | |
| | 0.8 | 0.8 | Effect % | 100 | 100 | 100 | 100 | 100 | 100 | 100 |
| | 0.8 | 0.8 | Colby | 96 | 100 | 100 | 100 | 100 | 100 | 100 |
| | | | exp. % | | | | | | | |
| | 0.8 | 0.16 | Effect % | 20 | 100 | 100 | 100 | 100 | 100 | 100 |
| | 0.8 | 0.16 | Colby | 15 | 91 | 95 | 100 | 100 | 93 | 94 |
| | | | exp. % | | | | | | | |
| | 0.8 | 0.032 | Effect % | 5 | 15 | 15 | 35 | 45 | 90 | 80 |
| | 0.8 | 0.032 | Colby | 15 | 10 | 19 | 19 | 28 | 41 | 58 |
| | | | exp. % | | | | | | | |

TABLE 3
Clothianidin and Bendiocarb/Anopheles gambiae

| | Concentration/ | Concentration/ | | Hours after contact to | | | | | | |
|---|---|---|---|---|---|---|---|---|---|---|
| | mg/m² | mg/m² | | the treated surface | | | | | | |
| | Clothianidin | Bendiocarb | | 0.25 h | 0.5 h | l h | 2 h | 3 h | 4 h | 24 h |
| Control | 0 | 0 | Effect % | 0 | 0 | 0 | 0 | 10 | 10 | 30 |
| Clothianidin | 50 | 0 | Effect % | 10 | 35 | 65 | 65 | 60 | 65 | 95 |
| alone | 20 | 0 | Effect % | 30 | 35 | 40 | 45 | 50 | 55 | 65 |
| | 5 | 0 | Effect % | 15 | 25 | 35 | 35 | 45 | 50 | 65 |
| Bendiocarb | 0 | 0.16 | Effect % | 15 | 100 | 100 | 100 | 100 | 100 | 100 |
| alone | 0 | 0.032 | Effect % | 10 | 25 | 25 | 25 | 35 | 35 | 80 |
| Clothianidin | 50 | 0.16 | Effect % | 30 | 100 | 100 | 100 | 100 | 100 | 100 |
| and | 50 | 0.16 | Colby | 24 | 100 | 100 | 100 | 100 | 100 | 100 |
| Bendiocarb | | | exp. % | | | | | | | |
| | 50 | 0.032 | Effect % | 15 | 65 | 65 | 70 | 75 | 75 | 75 |
| | 50 | 0.032 | Colby | 19 | 51 | 74 | 74 | 74 | 77 | 99 |
| | | | exp. % | | | | | | | |
| | 20 | 0.16 | Effect % | 20 | 100 | 100 | 100 | 100 | 100 | 100 |
| | 20 | 0.16 | Colby | 41 | 100 | 100 | 100 | 100 | 100 | 100 |
| | | | exp. % | | | | | | | |
| | 20 | 0.032 | Effect % | 15 | 90 | 90 | 100 | 100 | 100 | 100 |
| | 20 | 0.032 | Colby | 37 | 51 | 55 | 59 | 68 | 71 | 93 |
| | | | exp. % | | | | | | | |
| | 5 | 0.16 | Effect % | 10 | 100 | 100 | 100 | 100 | 100 | 100 |
| | 5 | 0.16 | Colby | 28 | 100 | 100 | 100 | 100 | 100 | 100 |
| | | | exp. % | | | | | | | |
| | 5 | 0.032 | Effect % | 20 | 85 | 100 | 100 | 95 | 100 | 100 |
| | 5 | 0.032 | Colby | 24 | 44 | 51 | 51 | 64 | 68 | 93 |
| | | | exp. % | | | | | | | |

### Metabolic-Resistant Anopheles Test

### Solvent: Acetone

To produce a suitable preparation of active compound combination the active compounds bendiocarb and dinotefuran were dissolved in acetone (for the control group only one active compound was dissolved in acetone). The active compound combination preparation (and the active compound preperations) were pipetted onto a glazed tile and, after drying, adult mosquitoes of the species Anopheles funestus metabolic-resistant strain FUMOZ-R (Hunt et al., Med Vet Entomol. 2005 September; 19(3):271-5) are placed onto the treated tile. The exposition time is 30 minutes.

0.25 hours, 0.5 hours, 1 hour, 2 hour, 3 hour, 4 hour and 24 hours after contact to the treated surface, the knock-down proportion of the test animals in % is determined. Here, 100% means that all mosquitoes have been killed; 0% means that none of the mosquitoes has been killed.

TABLE 4
Dinotefuran and Bendiocarb/Anopheles funestus

| | Concentration/ | Concentration/ | | Hours after contact to | | | | | | |
|---|---|---|---|---|---|---|---|---|---|---|
| | mg/m² | mg/m² | | the treated surface | | | | | | |
| | Dinotefuran | Bendiocarb | | 0.25 h | 0.5 h | l h | 2 h | 3 h | 4 h | 24 h |
| Control | 0 | 0 | Effect % | 0 | 0 | 0 | 0 | 0 | 0 | 30 |
| Dinotefuran | 4 | 0 | Effect % | 15 | 10 | 10 | 15 | 30 | 40 | 55 |
| alone | 0.8 | 0 | Effect % | 0 | 0 | 5 | 0 | 10 | 15 | 35 |
| Bendiocarb | 0 | 0.8 | Effect % | 100 | 100 | 100 | 100 | 100 | 95 | 100 |
| alone | 0 | 0.16 | Effect % | 0 | 80 | 80 | 45 | 50 | 20 | 90 |
| | 0 | 0.032 | Effect % | 0 | 5 | 5 | 5 | 10 | 10 | 40 |
| Dinotefuran | 4 | 0.8 | Effect % | 100 | 100 | 100 | 100 | 100 | 100 | 100 |
| and | 4 | 0.8 | Colby | 100 | 100 | 100 | 100 | 100 | 97 | 100 |
| Bendiocarb | | | exp. % | | | | | | | |
| | 4 | 0.16 | Effect % | 50 | 100 | 100 | 100 | 100 | 100 | 100 |
| | 4 | 0.16 | Colby | 15 | 82 | 82 | 53 | 65 | 52 | 96 |
| | | | exp. % | | | | | | | |
| | 4 | 0.032 | Effect % | 5 | 15 | 40 | 25 | 50 | 55 | 70 |
| | 4 | 0.032 | Colby | 15 | 15 | 15 | 19 | 37 | 46 | 73 |
| | | | exp. % | | | | | | | |
| | 0.8 | 0.8 | Effect % | 100 | 100 | 100 | 100 | 100 | 100 | 100 |
| | 0.8 | 0.8 | Colby | 100 | 100 | 100 | 100 | 100 | 96 | 100 |
| | | | exp. % | | | | | | | |
| | 0.8 | 0.16 | Effect % | 45 | 100 | 100 | 100 | 100 | 100 | 100 |
| | 0.8 | 0.16 | Colby | 0 | 80 | 81 | 45 | 55 | 32 | 94 |
| | | | exp. % | | | | | | | |
| | 0.8 | 0.032 | Effect % | 0 | 35 | 45 | 35 | 30 | 45 | 65 |
| | 0.8 | 0.032 | Colby | 0 | 5 | 10 | 5 | 19 | 24 | 61 |
| | | | exp. % | | | | | | | |

1. Active compound composition for controlling animal pests comprising bendiocarb or propoxur and secondly at least one further active compound selected from the group of neonicotinoids and phenylpyrazoles.

2. Active compound composition according to claim 1 comprising bendiocarb and secondly at least one further active compound selected from the group of neonicotinoids and phenylpyrazoles.

3. Active compound composition according to claim 2 comprising bendiocarb and secondly, as at least one further active compound selected from the group of dinotefuran and clothianidin.

4. An active compound composition according to claim 1 capable of being used to control arthropods.

5. An active compound composition according to claim 4 wherein the arthropods are mosquitos and/or bed bugs.

6. An active compound composition according to claim 5 capable of being used to control target-site- and/or metabolic-resistant mosquitos and/or bed bugs.

7. An active compound composition according to claim 5 capable of being used to control pyrethroid and/or carbamate-resistant mosquitos.

8. An active compound composition according to claim 5 capable of being used to control multi-resistant mosquitos.

9. An active compound composition according to claim 6 capable of being used to control insecticide-resistant mosquitos wherein the insecticide-resistant mosquitos are selected from the group of Anopheles gambiae and Anopheles funestus.

10. An active compound composition according to claim 5 capable of being used to control pyrethroid-resistant bed bugs.

11. An active compound composition according to claim 10, wherein the pyrethroid-resistant bed bugs have a Valine to Leucine mutation (V419L) and/or a Leucine to Isoleucine mutation (L925I) in a voltage-gated sodium channel alpha-subunit gene.

12. Material comprising an active compound composition according to claim 1.

13. Material according to claim 12, wherein the material is a bed bug bait which comprises means to attract bed bugs.

14. Method to control arthropods comprising using an active compound composition according to claim 1 or a material according to claim 12 to control said arthropods.

15. Method to overcome a target-site and/or metabolic-resistance in an arthropod comprising applying an active compound composition according to one of claim 1 to arthropods that have a target-site and/or metabolic-resistance.
